(19) United States
(12) Patent Application Publication
(10) Pub. No.: US 2011/0042491 A1
(43) Pub. Date: Feb. 24, 2011

(54) Fuel Injection Valve

(75) Inventors: Motoyuki Abe, Hitachinaka (JP); Tohru Ishikawa, Kitaibaraki (JP); Takehiko Kowatari, Kashiwa (JP); Yasuo Namaizawa, Naka (JP); Akiko Komeda, Musashino (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Automotive Systems, Ltd., Hitachinaka-shi (JP)

(21) Appl. No.: 12/918,596

(22) PCT Filed: Jul. 14, 2009
(86) PCT No.: PCT/JP2009/062729

§ 371 Date: Oct. 19, 2010

(30) Foreign Application Priority Data
Aug. 29, 2008 (JP) 2008-220678

(51) Int. Cl. B05B 1/30

(52) U.S. Cl. 239/584

(57) ABSTRACT

An injector used for an internal combustion engine, wherein force acting on a valve element due to flow of fuel is reduced. The shape of either a valve element front end or a valve seat surface of a fuel injection valve is adapted such that the distance between the valve element front end and the valve seat surface which is formed by a circular conical surface is greater than in the case when the shape from a valve element circular tube surface to a spherical surface which forms a seat is connected by a circular arc. As a result, the cross-sectional area of a flow path is rapidly increased from the valve seat surface, on the outer side of the valve element, and this reduces that portion of the valve element which receives pressure due to a reduction in static pressure, reducing force acting on the valve element.

### TECHNICAL FIELD

The present invention relates to a fuel injection valve used in internal combustion engines, in which a valve element abuts against a valve seat to thereby prevent leakage of a fuel and the valve element separates from the valve seat to perform injection.

### BACKGROUND ART

JP-B2-3737122 discloses a fuel injection valve, in which a spherical surface on a valve element side and a conical surface on a valve seat side abut against each other to thereby seal a fuel, a transition section is provided between a valve shaft and a conical section, and a sealing seat formed as a narrow spherical zone is provided between the transition section and the conical section.

### CITATION LIST

### [Patent Citation 1] JP-B2-3737122

### SUMMARY OF INVENTION

### Technical Problem

Electromagnetic type fuel injection valves are generally used for fuel injection valves that supply a fuel to internal combustion engines. Here, problems will be described taking an electromagnetic type fuel injection valve as an example. Electromagnetic type fuel injection valves are normally closed type electromagnetic valves, in which a valve element is normally pushed against a valve seat surface by a bias spring to bring about a closed state. When an electric current is introduced to a coil to generate an electromagnetic force, the valve element and the valve seat surface are caused to separate from each other to create a clearance to bring about an opened state.

Here, in the opened state, when a fuel passes through a clearance between the valve element and a valve seat, an increase in velocity of flow or in pressure loss is caused and a decrease in static pressure at a tip end of the valve element is caused. Therefore, the valve element in the opened state is pushed by fuel pressure in a valve closing direction.

In order to maintain the opened state against the force in the valve closing direction, it is necessary to increase an electric current introduced to a coil to increase an electromagnetic force, or to set a range of fuel pressure as used small, or to make a force, which is given by the bias spring, smaller than a predetermined value. Among these measures, there is a limit in electric power, which can be introduced to the coil, because of heat generation of the coil, attendant shortening of life, and thermal degradation of resin members. Also, because of the effect on engine combustion performance, it is not preferred that a usable range of fuel pressure be set small.

Here, when a force, which is given by the bias spring, is set small, there is caused a problem that a force, which closes the valve element, becomes small to bring about a decrease in responsibility. In the course of valve closing, the force of the bias spring and a fluid force by a fuel cause the valve element to perform a valve closing motion, and when the force by the bias spring is set small so that a workable maximum fuel pressure (maximum working fuel pressure) becomes large, a small fuel pressure enables the valve element not to sufficiently receive a force required for valve closing and time required for valve closing is prolonged. That is, a valve closing delay time is prolonged.

The valve closing delay time is a response delay time of a fuel injection valve related to a valve closing motion and a delay time which determines a controllable minimum injection quantity. That is, when a bias spring force is small, there is caused a problem that a valve closing delay time is prolonged and a controllable minimum injection quantity increases.

Accordingly, in order to make a controllable minimum injection quantity fairly small, in other words, to shorten a valve closing delay time, it is necessary to set a bias spring force large. Here, in order that a maximum working fuel pressure does not become small, it is necessary to decrease a fluid force acting on a valve element.

The invention has been thought of in view of the above and has its object to decrease a fluid force acting on a valve element.

### Technical Solution

In order to solve the above problems, according to the invention, a valve element or a seat member is shaped so that in a region extending from a spherical surface portion, which forms a sealing portion of the valve element, to a portion, which becomes in parallel to a cylindrical-shaped portion of the valve element, a clearance between a valve seat and the valve element is made larger than a distance between a circular arc, which connects between a terminal end of the spherical surface portion and the cylindrical-shaped portion, and a conical surface, which forms the valve seat. As a result that a fluid (fuel) increases in velocity of flow at a tip end of the valve element and dynamic pressure increases, so that static pressure decreases according to Bernoulli's theorem, or static pressure decreases due to pressure loss resulted at the tip end of the valve element, a major part of a force caused by the fuel to act on the valve element is a force due to the fact that the tip end of the valve element acts as a pressure receiving surface. Accordingly, when it is tried to decrease this force, it is necessary to decrease a fuel in velocity of flow, or to narrow a region, which is high in velocity of flow, to narrow a region for reception of the decreased static pressure. According to the invention, a region at the tip end of the valve element, which decreases in static pressure, or pressure loss to be occurred can be decreased by decreasing a region, in which a fuel is high in velocity of flow, in the vicinity of a sealing portion at the tip end of the valve element. As a result, it is possible to obtain a fuel injection valve, in which a bias spring force acting on the valve element can be increased and which is decreased in valve closing delay time and exhibits a good responsibility.

### ADVANTAGEOUS EFFECTS

According to the invention, it is possible to obtain a fuel injection valve, in which a force given by flow of a fuel acting on a valve element can be decreased and a maximum fuel pressure enabling the fuel injection valve to work can be increased, or which is made good in responsibility even at the time of low pressure by setting a bias spring force high. As a result, it is possible to obtain a fuel injection valve, in which, for example, a controllable minimum injection quantity is small and which realizes an internal combustion engine being made high in one of fuel consumption, exhaust, and output performances.

Other objects, features and advantages of the present invention will become more apparent from the following description of embodiments of the invention when taken in conjunction with the accompanying drawings.

### BRIEF DESCRIPTION OF DRAWINGS

FIG. 1 is a cross sectional view showing a first embodiment of a fuel injection valve according to the invention.

FIG. 2 is a cross sectional view showing, in enlarged scale, the neighborhood of a tip end of a valve element of the first embodiment of the fuel injection valve according to the invention.

FIG. 3 is a schematic view showing a force acting on a tip end of a valve element in a conventional fuel injection valve.

FIG. 4 is an enlarged view showing, in detail, a shape of the tip end of the valve element in the first embodiment of the fuel injection valve according to the invention.

FIG. 5 is a graph showing a clearance between the valve element and a valve seat in the first embodiment of the fuel injection valve according to the invention.

FIG. 6 is an enlarged, cross sectional view showing the neighborhood of a tip end of a valve element in a second embodiment of the fuel injection valve according to the invention.

FIG. 7 is a view showing change in cross sectional area of a flow passage at the tip end of the valve element in the second embodiment of the fuel injection valve according to the invention.

### EXPLANATION OF REFERENCE

101, 301 valve element
102, 302 valve seat member
103 guide member
104 nozzle holder
105 valve element guide
106 anchor
107 magnetic core
108 coil
109 yoke
110 spring
111 connector
112 fuel supply port
201 injection port
202 spherical surface of valve element
203 valve seat
204 conical surface
205 cylindrical-shaped portion
206 sliding cylindrical surface
303˜306 arrow
601 valve element
602 spherical body
603 position of a spherical surface which becomes in parallel to a cylinder
604 seat conical surface
605 seat member
606 flat surface portion
607 shaft portion

### DESCRIPTION OF EMBODIMENTS

Embodiments of an electromagnetic type fuel injection valve according to the invention will be described hereinafter.

### Embodiment 1

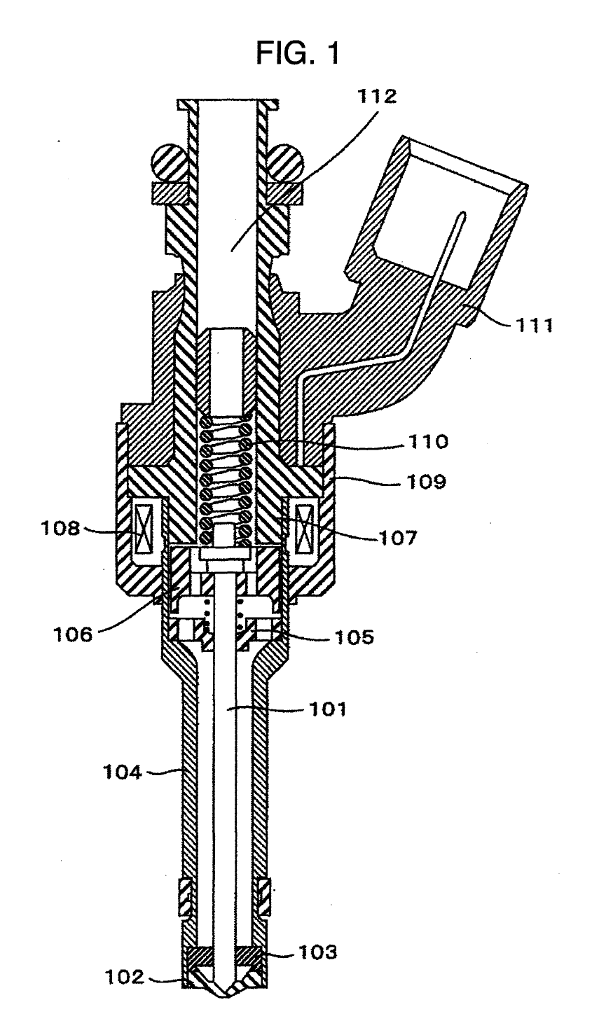

FIG. 1 is a cross sectional view showing a first embodiment of an electromagnetic type fuel injection valve according to the invention. The electromagnetic type fuel injection valve shown in FIG. 1 is an electromagnetic type fuel injection valve of in-cylinder direct injection type for gasoline engines.

In FIG. 1, a fuel is supplied from a fuel supply port 112 to be fed to an interior of the fuel injection valve. The electromagnetic type fuel injection valve shown in FIG. 1 is a normally closed type electromagnetically driven one and when a coil 108 is not energized, a valve element 101 is biased by a spring 110 to be pushed against a valve seat member 102, so that a fuel is sealed. At this time, fuel pressure as supplied in the in-cylinder injection type fuel injection valve is in the range of about 2 MPa to 25 MPa.

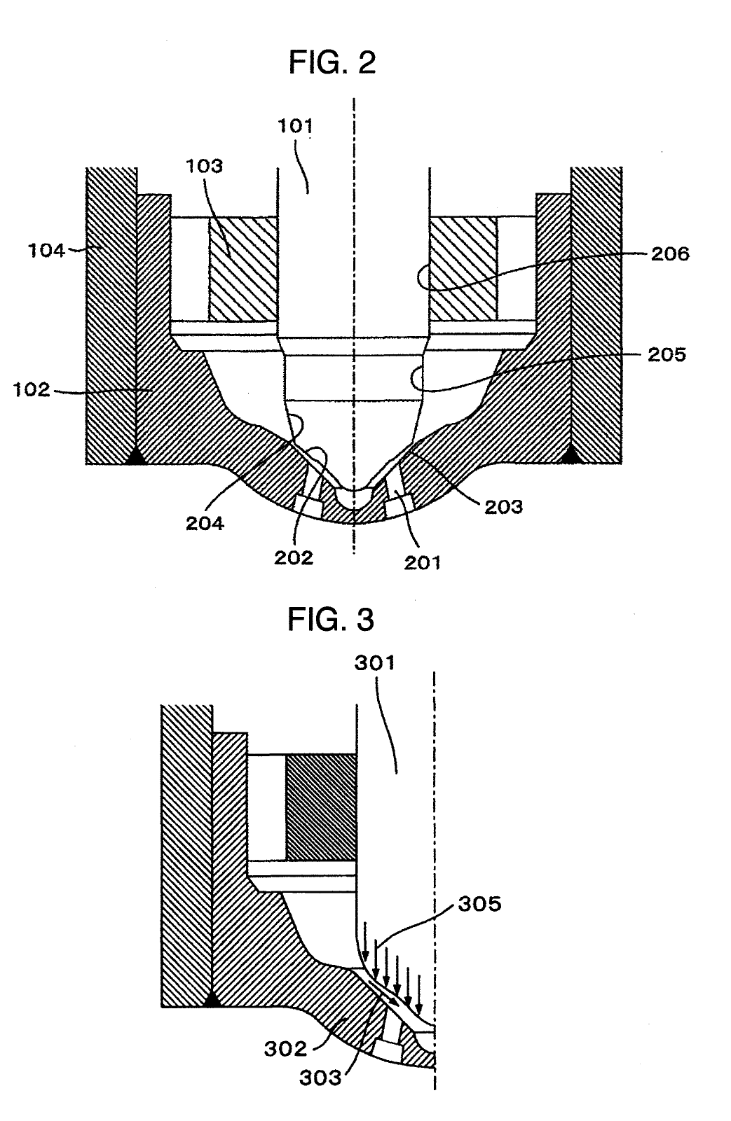

FIG. 2 is a cross sectional view showing, in enlarged scale, the neighborhood of injection ports provided at a tip end of the valve. When the fuel injection valve is in a valve closed state, the valve element 101 abuts against a valve seat 203, which comprises a conical surface provided on the valve seat member 102, to maintain sealing the fuel. A contact part of the valve element 101 is formed by a spherical surface 202 and contact between the valve seat 203 in the form of a conical surface and the spherical surface 202 is substantially in a linear contact state. Sealing portions, respectively, are formed on mutual contact parts of the valve element 101 and the valve seat 203, and fuel injection ports 201 are formed on the valve seat member 102 in a manner to be positioned downstream of the sealing portions in a fuel flow direction. When in the valve closed state, a force obtained by multiplying fuel pressure by an area of a circle (a circle defined by the contact parts) having a seat diameter is acting on the valve element 101.

When the coil 108 is energized, magnetic flux is generated on a core 107, a yoke 109, and an anchor 106, which constitute a magnetic circuit of the electromagnetic valve, so that magnetic attraction is generated between the core 107 and the anchor 106, between which a clearance is present. When the magnetic attraction become larger than the force produced by the bias of the spring 110 and the fuel pressure as described above, the valve element 101 is attracted toward the core 107 by the anchor 106 to bring about a valve opened state.

When put in the valve opened state, a clearance is generated between the valve seat 203 and the spherical surface 202 of the valve element and fuel injection is started. When fuel injection is started, energy given as the fuel pressure is converted into kinetic energy to reach the injection ports 201 to result in injection.

The valve element 101 together with the anchor 106 is enclosed in a nozzle holder 104. The valve element 101 is guided in two locations in a direction of driving by a guide member 103 provided on a tip end side, on which the sealing portions are formed, and a valve element guide 105 provided on a base end side, on which the anchor 106 is provided. The guide member 103 and the valve element guide 105 are provided on the nozzle holder 104 so as to guide the valve element 101 in two locations in a direction along a central axis of the valve element (a direction of valve axis).

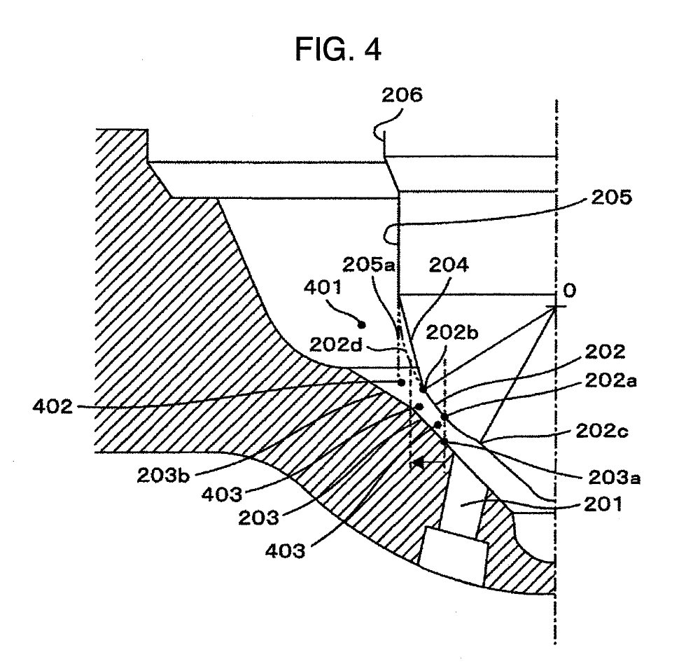

FIG. 3 is a schematic view showing a state of flow at a tip end of the fuel injection valve put in a valve opened state and a force caused by flow of fuel to act on the valve element. FIG. 3 shows a force exerted on a valve element 301 in a conventional fuel injection valve.

When the valve element 301 is displaced and the valve is put in a valve opened state, a fuel passes through a clearance between the valve element 301 and a valve seat member 302. It is important in restricting a displacement magnitude that the clearance between the valve element 301 and the valve seat member 302 be set comparatively small. That is, in order to make the fuel injection valve good in responsibility, it is important that a displacement magnitude don't become too large. Therefore, flow of a fuel passing through a small clearance increases in velocity of flow 303.

Generally, when a fuel increases in velocity of flow, dynamic pressure (ρv²)/2 (ρ indicates density of fluid and v indicates velocity of flow) increases and pressure loss becomes large in proportion to dynamic pressure. When pressure loss occurs in this manner, pressure below the valve element decreases. Also, when an increase in velocity of flow causes an increase in dynamic pressure, a part being high in velocity of flow decreases in static pressure according to Bernoulli's theorem.

The valve element receives a fuel pressure supplied on an upstream side thereof (for example, a position in contact with the spring 110) and is pushed back by fuel pressure on a downstream side thereof (that is, on the side toward the valve seat member 102), and a difference therebetween presents a force acting on the valve element. Accordingly, a decrease in static pressure due to conversion into kinetic energy and a decrease in static pressure due to pressure loss cause pressure indicated by arrows 305 to act as a force acting on the valve element at a tip end thereof and lowering the valve element in a valve closing direction.

In the present embodiment, the valve element is formed in external shape as shown in FIG. 4 in order to reduce a force which thus lowers the valve element in the valve closing direction. FIG. 4 is a view showing, in further enlarged scale than FIG. 2, the neighborhood of the valve element. The tip end of the valve element 101 includes a cylindrical-shaped portion 205 disposed downstream of a cylindrical-shaped portion 206, which is defined by a cylindrical-shaped surface to form a guide portion, and defined by a cylindrical-shaped surface being smaller in diameter than that of the cylindrical-shaped portion 206, and a downstream side of the cylindrical-shaped portion 205 is contiguous to a conical surface 204. The conical surface 204 is smoothly contiguous to the spherical surface 202, which provides for sealing. A side downstream of the spherical surface 202 is formed to be further pointed than the spherical surface 202.

The spherical surface 202 is formed with a seat portion 202a which comes into contact with a seat portion 203a of the valve seat 203, and in a region extending from an upstream side 202b to a downstream side 202c, a spherical surface portion is formed. A center of the spherical surface portion is positioned as indicated by O. In the present embodiment, the spherical surface 202 has the same radius as that of the cylindrical-shaped portion 205.

A wide angle conical surface 203b having a wider angle than that of the conical surface, which defines the valve seat 203 is formed upstream of the valve seat 203, and the wide angle conical surface 203b is contiguous to a conical surface, which defines the valve seat 203 inwardly (toward a valve axis) of a cylindrical-shaped surface forming the cylindrical-shaped portion 205 in a direction perpendicular to the valve axis.

In the cross sectional view of FIG. 4, in the case where the spherical surface 202, which forms a sealing at a tip end of the valve element, and a virtual cylindrical-shaped surface 205a, which is in parallel to the cylindrical-shaped surface of the cylindrical-shaped portion 205 are connected together by a circular arc (a virtual spherical surface extended toward an upstream side), a line like a two-dot chain line 202d (a virtual spherical surface) is defined. In the present embodiment, since the conical surface 204 is provided between the cylindrical-shaped portion 205 and the spherical surface 202, a clearance between the conical surface of the valve seat 203, which defines a seat, and the valve element 101 becomes wide as compared with the case where a tip end configuration of the valve element 101 is defined by a profile like the two-dot chain line 202d. A clearance between the valve element 101 and the valve seat 203 (including the wide angle conical surface 203b) is the shortest distance between the valve element 101 and the valve seat 203 (including the wide angle conical surface 203b). In the following descriptions, the valve seat 203 includes the wide angle conical surface 203b.

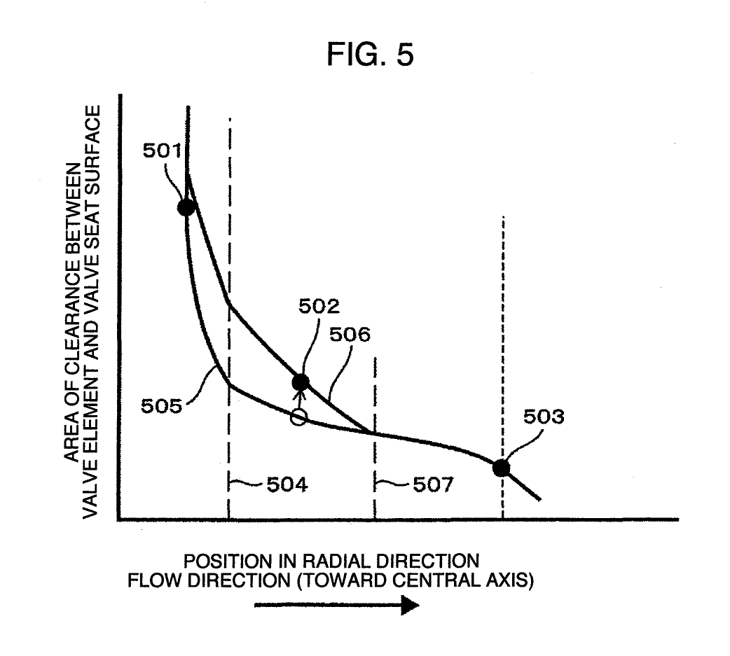

FIG. 5 is a graph, in which an axis of ordinates indicates a cross sectional area of a flow passage between a tip end of the valve element 101 and that conical surface, which defines the valve seat 203, and an axis of abscissas indicates a position in a radial direction. On the axis of abscissas, a flow direction is rightward and so a side toward a central axis (valve axis) of the fuel injection valve is on the right side.

When flow goes toward the central axis of the fuel injection valve, it will go in a direction, in which a radius decreases, thus showing a tendency that a cross sectional area of a flow passage decreases essentially and linearly.

Description will be given along positions in the flow direction. At a position, like a position 401 shown in FIG. 4, being larger in a radial direction than the virtual cylindrical-shaped surface 205a in parallel to the cylindrical-shaped surface of the cylindrical-shaped portion 205 of the valve element, the clearance is put in a state of being extremely large as shown in a position leftwardly of a point 501 in FIG. 5. In contrast, in the case where the valve element is shaped by connecting the virtual cylindrical-shaped surface 205a and the spherical surface 202 together by the circular arc (a virtual spherical surface) 202d, a clearance area shown by a line 505 in FIG. 5 is provided in a position, like a point 402, of a clearance between the valve element and the valve seat 203. In addition, a point 403 is positioned on a line being perpendicular to the valve seat 203 and passing through the seat portion 202a of the spherical surface 202.

In the present embodiment, a clearance enlarged portion is provided on a valve element portion between the cylindrical-shaped portion 205 and the spherical surface 202 to enlarge a clearance between the valve element 101 and the valve seat 203 further than the case where the valve element is shaped by connecting the virtual cylindrical-shaped surface 205a and the spherical surface 202 together by the circular arc (a virtual spherical surface) 202d. For example, it is preferred that the conical surface 204 as shown in FIG. 4 is provided. In the case where the conical surface 204 is provided, a clearance area between the valve element 101 and the valve seat 203 is larger than a clearance area indicated by 505, like 506 in FIG. 5.

In addition, in FIG. 5, a broken line 507 corresponds to a position at an end 202b of the spherical surface 202 and a broken line 504 corresponds to a position at an end of the wide angle conical surface 203b. The wide angle conical surface 203b is provided on the left side of the broken line 504.

In the present embodiment, also by providing the wide angle conical surface 203b, a clearance area between the valve element 101 and the valve seat 203 is larger in comparison with the case where the valve seat 203 is defined by a single conical surface. At this time, the valve element 101 may have a valve element configuration provided by connecting the virtual cylindrical-shaped surface 205a and the spherical surface 202 together by the circular arc (a virtual spherical surface) 202d. Even when the wide angle conical surface 203b is not provided, only the conical surface 204 of the valve element 101 enables enlarging a clearance area between the valve element 101 and the valve seat 203 as described above.

In case of providing the conical surface 204, it is preferred that the spherical surface 202 be provided up to an upstream side of a position (a seated position) in contact with the valve seat 203 and the spherical surface 202 and the conical surface 204 are connected smoothly together.

In this manner, by making a distance between a tip end surface of the valve element 101 and the valve seat 203 large, the cross sectional area of the flow passage between the valve element 101 and the valve seat 203 can greatly cover a wide region. That is, a clearance, as shown by the point 402 in FIG. 4, between the surface of the valve element 101 and the valve seat 203 can be made large as shown by a point 502 in FIG. 5 as compared with the case where the virtual cylindrical-shaped surface 205a and the spherical surface 202 are connected together by the circular arc (a virtual spherical surface) 202d. Therefore, a region being small in velocity of fuel flow can be made large. As a result of enabling enlarging a region being small in velocity of fuel flow, it is possible to achieve a decrease in pressure loss and to decrease a region being reduced in static pressure according to Bernoulli's theorem. In particular, since it is general that the tip end configuration of the valve element 101 is formed as a shape of a body of revolution, a surface outwardly of a seated position is large. Accordingly, when a decrease in static pressure is restricted outwardly of the seated position, an effect of decreasing a force acting on the valve element 101 is great. By making a valve element configuration between the spherical surface 202 and the cylindrical-shaped portion 205 as in the embodiment, it is possible to decrease a force acting on the valve element 101.

By decreasing the force acting on the valve element 101, it is possible to decrease a force, with which the valve element 101 is closed by fuel pressure, and as a result, that range of fuel pressure, in which the fuel injection valve can operate, can be set on a high pressure side. As a result, it is possible to provide a fuel injection valve, by which a fuel further atomized due to use in high pressure is injected. Also, it is possible to provide a fuel injection valve, in which fuel pressure is wide in range of use and of which injection quantity is made large in flow rate by the use at variable fuel pressures.

Alternatively, also by increasing the preset load of the spring 110, it is possible to maintain a workable range of fuel pressure. In this manner, in the case where the preset load of the spring 110 is made large, it is possible to make a valve closing motion of a fuel injection valve quick. Since a controllable minimum injection quantity is determined by time required for the valve closing motion of a fuel injection valve, the controllable minimum injection quantity of a fuel injection valve can be decreased when the preset load of the spring 1101 is made large. As a result, it is possible to provide a fuel injection valve capable of meeting an operating condition, which needs a further small injection quantity.

In addition, in the present embodiment, the cylindrical-shaped portion 205 is made a smaller cylindrical-shaped surface than the sliding guide surface 206 of the valve element in order to enlarge a region outwardly of the point 501 in FIG. 5, at which the cylindrical-shaped surface begins, and to reduce a region, in which a distance between the seat conical surface and the surface of the valve element 101 is reduced. While the effect of the present embodiment can be produced also in the case where the cylindrical-shaped surface of the sliding guide portion 206 and the cylindrical-shaped surface of the cylindrical-shaped portion 205 agree with each other, the cylindrical-shaped portion 205 is smaller in diameter than the sliding guide surface 206 whereby it is possible to decrease a cross sectional area affected by a decrease in static pressure.

### Embodiment 2

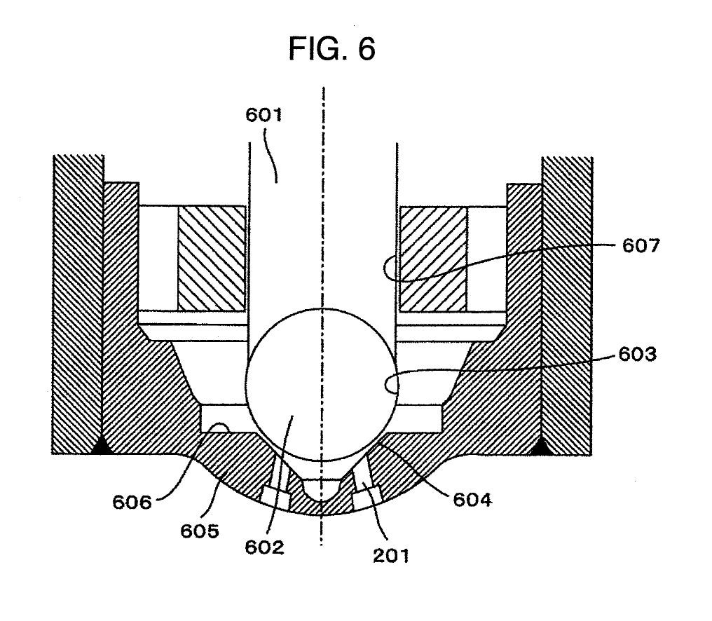

FIG. 6 is an enlarged, cross sectional view showing the neighborhood of a valve element 601 in a second embodiment of an electromagnetic type fuel injection valve according to the invention. In the second embodiment, there is provided upstream of a seat position of a seat conical surface 604 a conical surface having a larger opening angle than that of the seat conical surface 604, or there is provided upstream of a seat position of a seat conical surface 604 a flat surface portion like a surface 606. In this manner, that manner, in which the flat surface portion 606 is provided, is effective especially in the case where the valve element 601 is formed by a shaft portion 607 comprising a cylindrical-shaped surface and a spherical body 602. Generally, since a spherical body is supplied as a bearing, it has the advantage of comparatively readily obtaining a spherical body of high precision and high hardness. On the other hand, since the spherical body 602 and the shaft portion 607 serving as a guide surface are joined together as by welding or the like, working after being joined involves difficulties. According to the second embodiment of the invention, there is produced an effect that by working a seat member side without working a valve element side, a clearance between the valve element and the seat conical surface is enlarged and a force acting on the valve element is reduced.

In case of using the spherical body 602 for the valve element 601, a seat member is shaped so that in a region extending to a seat position from a position 603 in parallel to the shaft portion 607, the cross sectional area of a flow passage in a clearance between the valve element (the spherical body 602) and the seat conical surface 604 is enlarged as compared with the case where the position 603 and the seated position are connected together by a circular arc.

The flat surface portion 606 is provided and a point of intersection of the flat surface portion 606 and the seat conical surface 604 is set inwardly of a diameter of the position 603 in parallel to a cylinder corresponding to a sphere used for the valve element 601 but outwardly of a diameter of the seat position, whereby the cross sectional area of a flow passage in a clearance between the seat conical surface 604 and the spherical body 602 is enlarged while oiltightness of the seat is ensured.

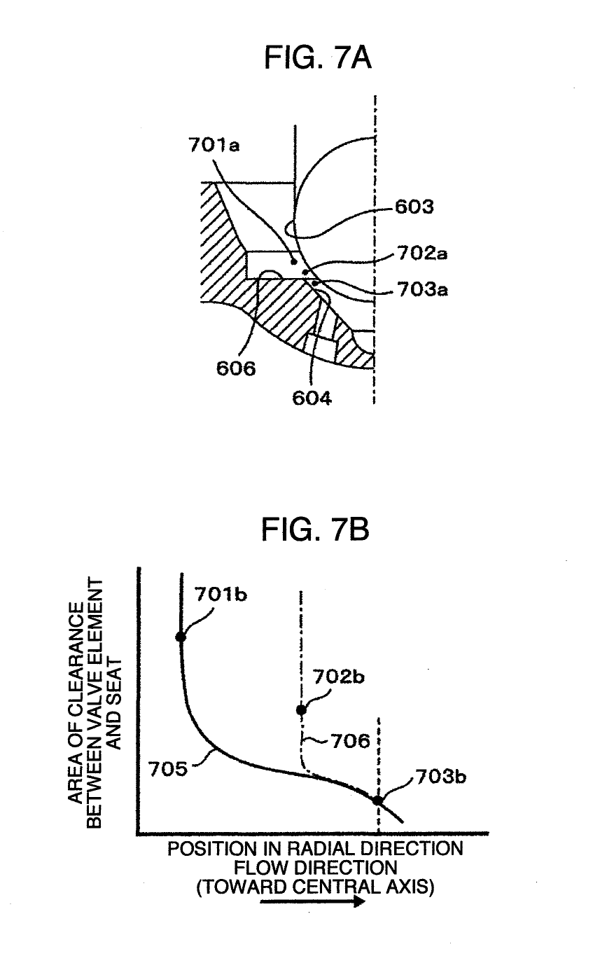

FIG. 7 is an enlarged view of the neighborhood of the valve element showing change in cross sectional area of a clearance and a graph showing the relationship of the cross sectional area of a flow passage. As shown in FIG. 7(a), at a point 701a in a fluid passage having the same diameter as that of the position 603 of the spherical body 602 in parallel to a cylinder, the cross sectional area of a flow passage is large as shown by a point 701b in FIG. 7(b). A clearance defined between the spherical body 602 and the seat conical surface 604 assumes a curve narrowing toward an inside of a spherical surface as shown by a line 705.

In contrast, according to the present embodiment, outside a point 702a in a fluid passage at a point of intersection of the flat surface portion 606 and the seat conical surface 604, a clearance between the valve element and the seat conical surface can be enlarged as shown by a line 706. That is, the provision of the flat surface portion 606 enables making the cross sectional area of a passage large as shown by a line 706 even in a region, in which a clearance is essentially narrow as shown by the line 705.

As a result, it is possible to narrow a region, in which a large velocity of flow caused by narrowness of a fluid passage is generated, outside a seat position 703b (on an upstream side in a flow direction). Therefore, a decrease in static pressure and pressure loss due to an increase in dynamic pressure can be restricted and by decreasing area of influence, it is possible to decrease a force acting on the valve element 601 in the valve closing direction.

While the above description has been given with respect to the embodiments, it is apparent to those skilled in the art that the invention is not limited thereto but susceptible of various changes and modifications within the spirit of the invention and the scope of the appended claims.

### INDUSTRIAL APPLICABILITY

While an in-cylinder direct injection type electromagnetic fuel injection valve for gasoline engines has been described by way of example, the invention is effective in port injection type electromagnetic fuel injection valves for gasoline engines and fuel injection valves driven by piezo elements and magnetostrictive elements.

1. A fuel injection valve including a valve seat surface formed by a conical surface, a valve element, which abuts against the valve seat surface to seal a fuel, a first guide portion, which guides the valve element in a direction of movement thereof in a vicinity of the valve seat surface, and a second guide portion, which guides the valve element in the direction of movement thereof in a position away from the valve seat surface relative to the first guide portion, wherein the valve is opened by the valve element separating from the valve seat surface, characterized in that the valve element includes an abutting portion formed to assume a spherical surface shape to abut against the valve seat surface, a first cylindrical-shaped surface portion positioned on an upstream side of the abutting portion in a fuel flow direction and guided by the first guide portion, and a second cylindrical-shaped surface portion positioned on a downstream side of the first cylindrical-shaped surface portion and on an upstream side of the abutting portion to be smaller in diameter than the first cylindrical-shaped surface portion, and there is provided on at least one of the valve element or the valve seat surface a clearance enlarged portion configured so that a clearance between a valve element portion between the abutting portion and the second cylindrical-shaped surface portion and the valve seat surface becomes larger in comparison with a case where the spherical surface shape of the abutting portion is provided to extend to a position in parallel to the second cylindrical-shaped surface portion, and the valve seat surface is formed by a single conical surface.

2. The fuel injection valve according to claim 1, characterized in that the clearance enlarged portion is structured by a conical surface of the valve element formed between the second cylindrical-shaped surface portion and the abutting portion.

3. The fuel injection valve according to claim 1, characterized in that there is provided on an upstream side of the conical surface which forms the valve seat surface a wide angle conical surface being wider in angle than the conical surface, which forms the valve seat surface, and the wide angle conical surface connects to the conical surface, which forms the valve seat surface, inside the second cylindrical-shaped surface portion in a direction perpendicular to a valve axis.

4. The fuel injection valve according to claim 1, characterized in that there is provided on an upstream side of the conical surface, which forms the valve seat surface, a flat surface portion, and the flat surface portion connects to the conical surface, which forms the valve seat surface, inside the second cylindrical-shaped surface portion in a direction perpendicular to a valve axis.
